(19) United States
(12) Patent Application Publication
(10) Pub. No.: US 2025/0083891 A1
(43) Pub. Date: Mar. 13, 2025

(54) GRAVIMETRIC METERING UNIT HAVING A MAGNETIC CONNECTION BETWEEN THE CONVEYING SCREW AND ITS HOLDER

(71) Applicant: K-TRON TECHNOLOGIES, INC., Sewell, NJ (US)

(72) Inventors: Men BERNEGGER, Zurich (CH); Rolf LEHMANN, Ammerswil (CH); Urs HELFENSTEIN, Seengen (CH)

(73) Assignee: K-TRON TECHNOLOGIES, INC., Sewell, NJ (US)

(21) Appl. No.: 18/709,709

(22) PCT Filed: Nov. 14, 2022
(86) PCT No.: PCT/IB2022/060935

§ 371 Date: Nov. 27, 2024

(30) Foreign Application Priority Data
Nov. 15, 2021 (CH) CH070558/2021

(51) Int. Cl. B65D 83/00

(52) U.S. Cl. CPC B65D 83/762

(57) ABSTRACT

A gravimetric metering unit for bulk material includes a metering device, which has a container for bulk material to be metered and a base unit. The base unit has a screw conveyor, which is operably held in position and driven by means of a holder. The screw conveyor and the holder can be axially plugged together and are designed such that they can be operably fastened to each other by means of a plug-in connection. The plug-in connection is a magnetic connection.

The present disclosure relates to a gravimetric metering unit for bulk materials according to the preamble of claim 1, to a conveying arrangement for a metering device according to the preamble of claim 17, and to a screw conveyor according to the preamble of claim 18.

Gravimetric metering devices, also known as loss-in-weight feeders, are widely used in many branches of industry for all kinds of flowable or bulk materials, i.e. bulk materials, as long as they can be conveyed by a gravimetric metering device at all. The bulk materials are dispensed into a container, from this into a base unit located below it and from the metering device by a conveyor located in the base unit. The metering device is located on a scale, so the weight registered by the scale is the gross weight, i.e. the known and constant weight of the metering device components (tare) plus the variable weight of the bulk material currently present in the container and in the base unit (net weight).

In this manner, the scale continuously registers the weight loss of the entire metering device during operation, and thus, due to the constant weight of the metering device, the weight loss of the bulk material present in the metering device, so that a controller of the metering device can determine the actual mass flow of the bulk material dispensed from the weight loss and, in comparison with a predetermined target mass flow, control the dispensing conveyor accordingly in order to minimize the difference between the actual and target mass flow.

Very precise control of the output mass flow may be necessary, for instance in the field of pharmaceuticals or when color pigments are to be added in industrial manufacturing. In addition, the target mass flow can be small, for instance for the above-mentioned color pigments and in the production of medicines (e.g. less than a kilogram per hour), or large, for instance in the field of plastics production and mining (e.g. more than 1 t per hour), wherein precise metering may also be necessary for such conveying capacities.

All types of precise scales are often used, with a resolution over their weighing range of 1:100,000 and more, including those with vibrating wire sensors, for example those known under the name SFT-III, SFT-II-M and SFT-II-L from Coperion K-Tron. These scales have a resolution of up to 1:4,000,000 so that precision metering can be carried out without any problems, even with a container capacity of several hundred kilos and a delivery rate of several tons per hour. If a resolution of 1:1,000,000 is used, for example, the weight can still be recorded to an accuracy of 1/10 g with a scale capacity of 100 kg and then used for metering.

In order to utilize the precision of the scales for metering, non-vertical, i.e. horizontal or inclined conveyors, are utilized in embodiments as the fluid-dynamic behavior of the bulk material can be controlled somewhat better in this manner, as gravity does not act in the conveying direction with horizontal conveyors and thus does not interfere. Longer screw conveyors are well suited as horizontal conveyors, as the actual flow rate can be varied quite easily and without delay when using a suitable drive by means of its rotational speed and the distance from the mass flow from the hopper to a collecting container located outside the metering unit can be effectively bridged without any disadvantages in the actual mass flow itself.

Usually, an end shaft of the screw conveyor in a metering device of the type mentioned is clamped in a holder, whereby the holder supports the screw conveyor such that it is precisely aligned in its conveyor pipe and rotates at the speed required for metering. The holder transfers changing, even high torques with constantly changing speeds to the conveying screw precisely and without play if necessary.

For maintenance, especially cleaning, or for changing the conveying screw, it must be possible to remove it from the holder and reinsert it.

This is done, for example, by removing a conveying arrangement, i.e., an assembly consisting of a screw conveyor and the holder, as a whole from the metering device and disassembling and assembling it at a location separate from the metering device. Alternatively, conveying arrangements have become known which have a driven drive mandrel, for example of a gear connected to a drive motor, as a holder, wherein the conveying screw has a receiving opening on the end face for receiving the drive mandrel and can thus be plugged thereon.

A bayonet-type lock is provided which locks the conveying screw onto the drive mandrel for metering operation in a positionally fixed and rotationally fixed manner. For this purpose, a locking element is inserted into the receiving opening of the conveying screw, which screw extends over part of its cross section and is crescent-shaped when viewed across the cross section, and the drive mandrel is adapted over its length to match the locking element in cross section so that the conveying screw can still be plugged onto the drive mandrel despite its locking element. In addition, a groove is provided in the drive mandrel, into which groove the locking element can be inserted by appropriately rotating the conveying screw so that it locks in the manner of a bayonet lock.

The disadvantage of this arrangement is that the production of the conveying arrangement is complex with regard to the precision required for metering. For example, the groove in the drive mandrel must be designed with a small tolerance for high metering precision, which may require the groove to be produced by electrical discharge machining. In addition, it is difficult to securely fasten the locking element in the opening of the screw conveyor, since even the slightest welding errors during the required welding process can make the screw conveyor unusable.

Accordingly, the object of embodiments of the present disclosure is to provide a metering unit or a conveying arrangement for a metering device which is cost-effective to manufacture.

This object is achieved by a metering unit having the characterizing features of claim 1, by a conveying arrangement having the characterizing features of claim 17, and by a screw conveyor having the characterizing features of claim 18.

Because a magnetic connection is provided, the connection itself can be produced inexpensively, which opens up the possibility of also inexpensively producing additional features in the conveying arrangement that are related to the magnetic connection.

In addition to the object addressed, the magnetic connection saves time during maintenance, cleaning and even when changing a conveying screw.

Further embodiments comprise the features of the dependent claims.

Embodiments will be described in somewhat more detail below with reference to the drawings.

In the figures:

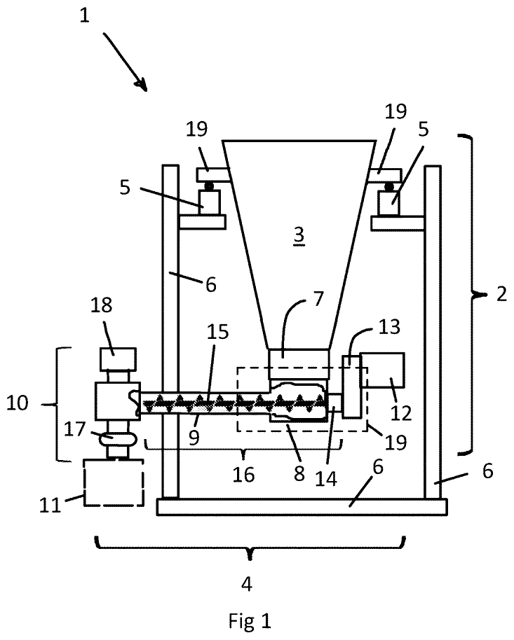

FIG. 1 schematically shows a gravimetric metering unit 1 from the prior art for bulk materials of the type mentioned above. In the metering unit 1, a metering device 2 with a hopper 3 and a base unit 4 is suspended above scales 5 in a frame 6.

During operation, the hopper 3 is filled with bulk material, which falls here via a transition hopper 7 (which can also be omitted) of the base unit 4 into a conveyor container 8, through which a conveying screw 15 protrudes, which screw conveys the bulk material from right to left into an output line 10, via which the bulk material reaches a further conveyor section 11 (indicated by dashed lines) for further processing. The hopper is refilled before it is empty.

The base unit 4 comprises, in addition to the conveyor container 8, a drive motor 12 which drives the conveying screw 15 by means of a gear 13, which in turn is placed on the mandrel of a holder 14 and runs through a conveyor pipe 9 to the output line 10 downstream of the conveyor container 8. The conveying screw 15 together with the holder 14 forms a conveying arrangement 16. For the sake of clarity, the conveyor container 8 and the conveyor pipe 9 are shown cut open so that the conveying screw 15 is visible.

Furthermore, the base unit 4 also comprises the output line 10, which is mechanically decoupled from the further conveyor section 11 by a bellows 17 and is pneumatically decoupled by a pressure compensation element 18 so that weighing of the metering unit 2 cannot be influenced by the further conveyor section 11.

The metering device 2 rests on the scales 5 via supports 19, which scales thus register the weight of the metering device 2 and the weight of the bulk material located in the hopper 3 (and in the base unit 4). If, during gravimetric operation of the metering unit 2, bulk material is discharged into the further conveyor section 11 by the rotation of the conveying screw 15, its weight is reduced accordingly, which is registered by the scales 5 and in turn evaluated by a controller (not shown in order to reduce the complexity of the figure). The weight reduction corresponds to the actual mass flow of discharged bulk material, which must be adjusted to the target mass flow. For this purpose, the controller continuously corrects the speed of the conveying screw 15 by means of the drive motor 12 in accordance with a control algorithm that is generally known to a person skilled in the art.

The flow behavior of the various bulk materials may be unproblematic or highly complex. There are bulk materials with a tendency to shoot through even a horizontal conveying screw 15 due to the pressure prevailing in the container 3, but also those which continuously form bridges in the container 3 so that the turns of the conveying screw 15 are only partially filled, and if a bridge collapses, turns are then filled in a compressed manner, i.e. over-filled, which is often the case with small, powder-like particles. Agitators provided in the hopper can dampen such effects but cannot eliminate them. Temperature, humidity, etc. can influence these parameters depending on the type of bulk material. Depending on the situation, the speed of the conveying screw must be controlled in coordination with the above-mentioned possible resolution of the scale with as little delay as possible, as precisely as possible and with the sometimes necessarily greatly changing torque (with a corresponding axial load on the conveying screw 15). This requires precise clamping of the conveying screw 15 in the holder 14 and is one reason why, as mentioned above, a complex bayonet lock is provided in the prior art, for example.

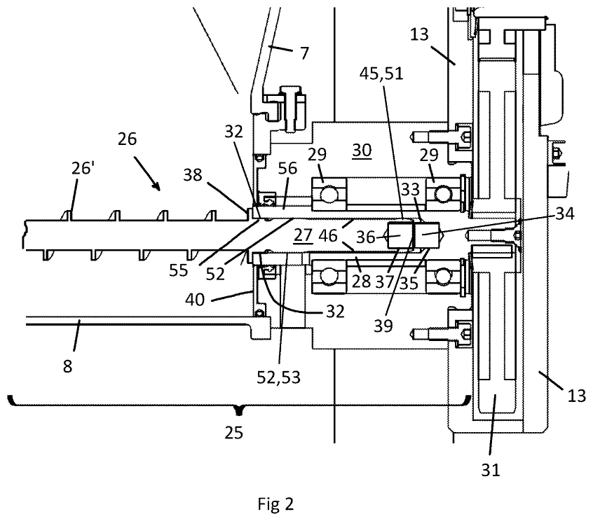

FIG. 2 shows a section through a region of a metering unit 1 or a metering device 2 with a conveying arrangement 25. The region shown in FIG. 2 corresponds to the dashed region 19 of the metering unit 1 shown in FIG. 1.

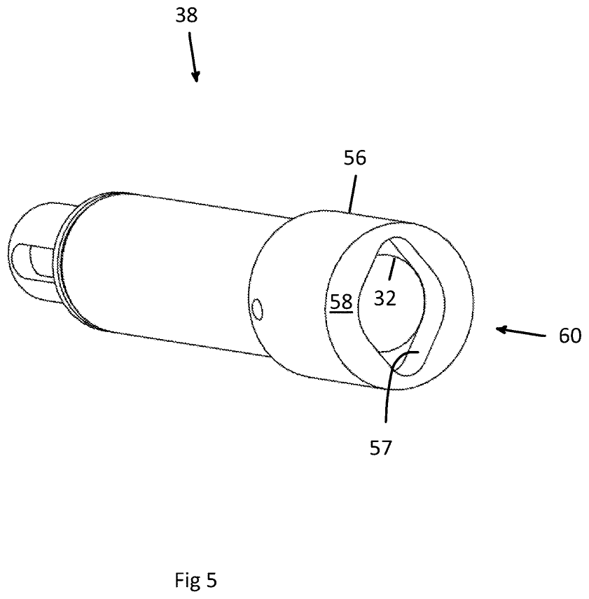

A conveying screw 26 with a conveying helix 26′, here with a small diameter (for a conveying screw with a large diameter; see FIG. 5) can be seen here, which conveying screw protrudes through a conveyor container 8 arranged on a transition hopper 7. The conveying screw 26 is clamped by a shaft 27 into a holder 28, which in turn is rotatably mounted in a housing 30 by means of ball bearings 29, wherein the housing 30 is in turn arranged on the gear 13. In the embodiment shown, the holder 28 is screwed directly onto a gear wheel 31 of the gear 13. The motor 12 thus drives the holder 28 and thus the conveying screw 26 by means of the gear wheel 31 of the gear 13.

It follows that, in a metering device 2 or a metering unit 1 in embodiments, the holder 28 is rotatably mounted in a housing 30 by means of ball bearings 29 and this housing 30 is arranged on a gear 13 of the drive for the conveying screw 26, wherein, in embodiments, a gearwheel 31 of the gear 13 is directly connected to the holder 28.

The holder 28 has an opening 32 into which the shaft 27 of the conveying screw 26 can be inserted in the axial direction so that the opening 32 receives the shaft 27, wherein a magnetic element designed here as a permanent magnet 34 is provided on the bottom 33 of the opening 32 and is, in embodiments, located in a bore 35 in the bottom 33 of the opening 32 and is, in embodiments, glued therein. A commercially available permanent magnet, for example a neodymium magnet, can be used as the magnet 34.

The shaft 27 of the conveying screw 26 is in turn also provided in the embodiment shown with a magnetic element, in embodiments, designed as a permanent magnet 36, which is arranged, for example glued, in the end face of the shaft 27, here in a bore 37, and is also, in embodiments, designed as a permanent magnet, for example as a neodymium magnet.

This results in a gravimetric metering unit or a metering device for bulk materials, in which the conveying screw 26 has a shaft 27 provided for interaction with the holder 28 and the holder 28 has an opening 32 for receiving the shaft 27, and wherein the end face of the shaft 27 facing the holder 28 and the bottom 33 of the opening 32 each have a magnetic element, in embodiments, a permanent magnet 34, 36. During operation, the magnets 34, 36 form a magnetic connection between the conveying screw 26 and the holder 28 of the conveying arrangement 25.

Also, in embodiments, a conveying arrangement 25 for a metering unit 1 or a metering device 2 is provided, comprising a conveying screw 26 and a holder 28 for said conveying screw, wherein the conveying screw 26 and the holder 28 can be axially plugged together and are designed such that they can be operably fastened to each other by means of a plug-in connection, wherein the plug-in connection is a magnetic connection. In embodiments, the magnetic connection is designed such that the fastening magnetic force acts on the conveying screw 26 in the axial direction and pulls it against the holder 28.

The shaft 27 of the conveying screw 26 is limited at the beginning of the shaft 27 by a stop element, in embodiments designed as a flange 38 (here projecting radially). In embodiments, the stop element strikes the holder 28 and thus determines the axial position of the screw conveyor 27 operably inserted into the holder 28. The depth to which the shaft 27 enters the holder 28 (or into the bearings of the flange 38) is, in embodiments, of such a depth that a gap 39 remains between the magnets 36, 34 during operation of the conveying arrangement 25, which protects the magnets, which usually consist of a brittle material, from striking one another during insertion. However, it is also possible in principle not to provide a gap. For another advantage of the gap 39, see below:

During operation, the magnetic connection fastens the conveying screw 26 in its operable position via the gap 39 with an axially acting force of 5 N to 20 N, 8 N to 12 N in embodiments, 9 N to 11 N in embodiments, directed against the holder 28. Since the magnetic attraction force rises steeply very shortly before the contact between the magnets, but the rise is no longer steep but comparatively flat when the distance between the magnets is slightly increased, the gap can be determined by suitable selection of the magnetic elements (here the permanent magnets 34, 36) and by the size of the gap 39 (here via the position of the stop shoulder 38 on the shaft 27) in such a way that, on the one hand, the above-mentioned forces act and, on the other hand, the gap is large enough that the magnetic attraction force is still comparatively flat. The flat profile allows the tolerances relating to the position of the stop shoulder 38 and the magnets 34,36 to be kept comparatively large and thus cost-effective during production. The width of the gap 39 is between 0.2 mm and 1.2 mm in embodiments, 0.6 mm to 0.8 mm in embodiments, and 0.7 mm in embodiments, whereby the above-mentioned forces can be achieved with commercially available permanent magnets. It should be noted here that the conveying screw 26 is thereby quite sufficiently secured in the holder 28 during operation by this magnetic fastening, since the bulk material being conveyed exerts a reaction force on the conveying screw 26 in the direction of the holder, but is also sufficient to prevent undesirable displacement, at the same time allowing the conveying screw 26 to be conveniently replaced with another conveyor element by means of a slight jolt. For large-diameter screw conveyors, however, see the description for FIG. 5.

In embodiments, this results in the stop element, here the flange 38, being positioned on the shaft 27 in such a way that, when the conveying screw 26 is in the operably inserted position in the holder 28, a gap remains between the magnetic elements (in the embodiment shown, the permanent magnets 36, 34) of the shaft 27 and the holder 28, which gap is between 0.2 mm and 1.2 mm in embodiments, between 0.6 and 0.8 mm in embodiments, and is 0.7 mm wide in embodiments. As mentioned above, in a specific case a person skilled in the art can easily select the required commercially available magnets from the manufacturers' catalogs.

The shaft 27 further has a camber 45 which serves to facilitate the insertion of the shaft 27 into the opening 32 of the holder 28. The tolerances for the operationally reliable seating of the shaft 27 in the holder 28 are comparatively small so that the shaft 27 must be positioned so as to be precisely radially aligned on the opening 32 when inserted, which is technically not easy to do and can take time to achieve, since even a slight tilt makes it impossible to insert the shaft 27 into the opening 32. This difficulty is further increased by the magnet 36, which, in the event of a slight deviation in the axial alignment, deflects the shaft even further due to its attraction to the wall of the opening 32 so that the assembly is actually made even more difficult.

The camber now allows the shaft 27 to be placed at an angle in the opening 32 and pushed in slightly until the shaft 27 can easily be correctly aligned during insertion. For this purpose, it is of course necessary that the shaft 27 has a mounting portion 46 of smaller diameter which adjoins the camber 45 and extends toward the flange 38, since otherwise the shaft 27 could not be inserted into the opening 32 in a tilted position. In other words, the camber projects beyond the mounting portion 46 in the radial direction.

Finally, it can be seen from the drawing that the housing 30 is covered by a cover plate 40, which here forms a portion of the side wall of the conveyor container 8.

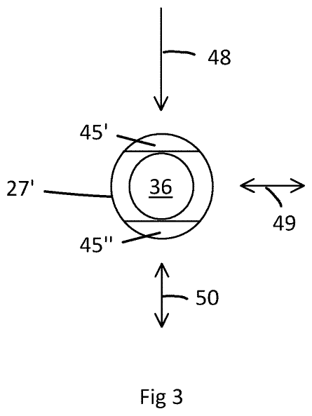

FIG. 3 shows a view of a shaft 27′, slightly modified compared to the shaft 27, from the front as seen from the opening 32 of the holder 28 (FIG. 2), which itself is not visible in FIG. 3. Shown is the magnet 34 inserted into the end face of the shaft 27′ as well as two subregions 45′ and 45″ of a camber on the end face of the shaft 27′.

If a shaft 27, 27′ is inserted into the holder 28, the gaze of a fitter standing behind the shaft 27′ falls in a direction indicated by the arrow 48, for example from above, onto the shaft 27, 27′ and the opening 32 (which is not visible in the drawing, since the view of the shaft 27′ is shown from this direction). A lateral deviation of the axis of a shaft 27, 27′ in the direction of the double-headed arrow 49 with respect to to the direction of the axis of the holder 28 is then comparatively easy to see and can accordingly be corrected more easily, whereas an incorrect alignment of the shaft 27, 27′ in the viewing direction (double-headed arrow 50) is difficult to notice. Accordingly, the camber 45′ on the shaft 27′ can be only partially formed in one direction, here in the vertical (direction of the double-headed arrow 50) so that it is substantially only effective in the viewing direction 48. Then the camber, here with the subregions 45′ and 45″, projects beyond the shaft 27′ at least in a radial direction the mounting portion, which is not visible in the figure because it is covered. Analogously, the mounting portion can also be formed in only one direction.

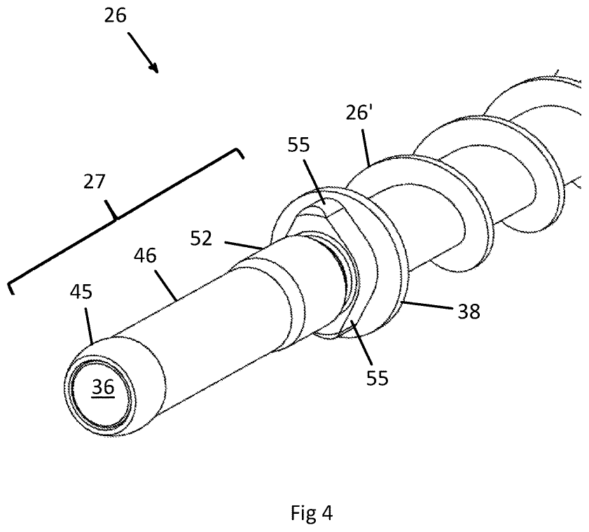

A shaft 27′ modified as shown in FIG. 3 makes sense if, compared to the embodiment shown in FIG. 2, not only a mating portion 52 acting as a centering surface (see FIGS. 2 and 4) but also a second mating portion is provided on the shaft 27′ so that the shaft is easily supported over its entire rotational position of 360° even without cambering, or only with partial cambering.

This results in a gravimetric metering unit for bulk materials or a conveying arrangement in which, in embodiments, the shaft 27′ of the screw conveyor 26 has a radially outwardly directed camber 45 on its end face, which camber projects beyond an adjoining mounting portion 46 extending toward the conveying helix 26′ of the screw conveyor 26 at least in one radial direction 50, in embodiments in all radial directions, in such a way that the shaft 27 can be placed in the opening 32 of the holder 28 so as to be slightly tilted in at least one direction and can be guided therein over a first section with the camber 45.

It should be noted here that the holder and then also accordingly the shaft can be designed with stepped diameters over the length of the holder. Then the camber must be placed where the shaft must be inserted into the narrowest part, with the result that the camber no longer has to be arranged on the end face, but set back therefrom, toward the stop shoulder.

This results in a gravimetric metering unit for bulk materials or a conveying arrangement in which the shaft 27, 27′ of the screw conveyor 26 in embodiments has a radially outwardly directed camber 45′, 45″ which projects beyond an adjoining shaft portion extending toward the end face of the shaft 27, 27′ and an adjoining mounting portion 46 extending toward the tip of the screw conveyor at least in one radial direction 50, in embodiments in all radial directions, such that the shaft 27, 27′ can be placed in a portion of the holder associated with the camber so as to be slightly tilted in at least one direction 50 and can be guided into this portion with the camber over a first section.

Furthermore, a screw conveyor according to claim 15 is provided, wherein the shaft 27 of the screw conveyor 26, in embodiments, has a radially outwardly directed camber 45 on its end face, which camber projects beyond an adjoining mounting portion 46 extending toward the conveying helix 26′ of the screw conveyor 26 at least in a radial direction 50, in embodiments in all directions, such that the shaft 27 can be placed in an opening 32 or into a step of a holder 28 associated with the screw conveyor 26 so as to be slightly tilted in at least one direction 50 and can be guided therein over a first section with the camber 45.

In embodiments, the camber 45 is formed to fit perfectly with the portion of the opening 32 in which it is located in the operably inserted position of the screw conveyor 26 such that the screw conveyor 26 is operably fitted into the holder 28 at a first location 51 (see FIG. 2) on the shaft 27.

In embodiments, the shaft 27 of the screw conveyor 26 has, within the length in which it projects into the opening 32 of the holder 28 during operation, a mating portion 51 whose external dimensions are designed to fit, over a length, perfectly with the portion of the opening 32 in which it is located in the operably inserted position of the screw conveyor 26, such that the screw conveyor 26 is operably fitted into the holder at a second location 53 (opposite a first location, such as a camber 45; see FIG. 2) on the shaft and is thus aligned in the holder 28 in the axial direction with the desired tolerance. When installed, the mating portion 51 contacts the opening 32 over a length, in contrast to the camber (45, 45′, 45″), which contacts the opening 32 substantially along a line.

In embodiments, the opening 32 of the holder can then be tubular, with a constant inner diameter over the length in which the shaft of the conveying screw projects into its opening 32 without cams (see FIGS. 4 and 5) during operation.

FIG. 4 shows the conveying screw 26 in a view from the end face of the shaft 27, with the magnet 36 inserted therein, the camber 45, the mounting portion 46, and the mating portion 52. Furthermore, the stop shoulder 38 is visible, and in front of it a double locking cam 55, which locks the conveying screw 26 inserted into the holder in a rotationally secure manner.

FIG. 5 shows a holder 38 in a side view from the mouth 60, wherein its opening 32 is visible, and a head 56 in which there is a recess 57 which is formed to match the locking cam 55. An end surface 58 forms a stop surface for the stop shoulder 38 of the conveying screw 26.

The arrangement shown in FIGS. 4 and 5, together with the magnetic plug-in connection, forms a simple and cost-effective rotationally secure connection in the axial direction between the conveying screw and its holder. It should be noted that a person skilled in the art can of course design the shape of the cam differently but suitable for the purpose shown in the specific case.

In embodiments, this results in a gravimetric metering unit for bulk materials or a metering device in which the shaft of the screw conveyor has at least one cam in the end portion facing the screw spiral, which cam, during operation, fastens the conveying screw in the holder in a rotationally secure manner with a mating recess in the end portion of the holder facing the screw spiral. Furthermore, this results in a screw conveyor in which the shaft of the screw conveyor, in embodiments, has at least one cam projecting radially from it in the end portion facing the screw spiral.

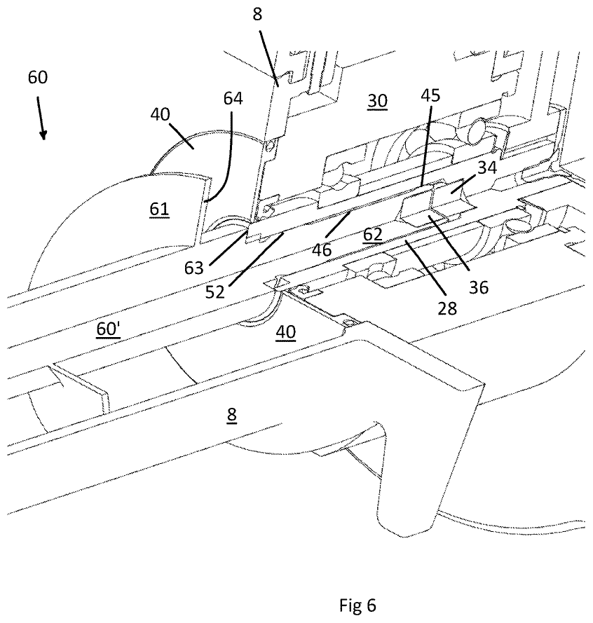

FIG. 6 shows a 3D view of the cutaway arrangement according to FIG. 2, but with a different conveying screw 60, the portion 60′ of which with the conveying helix 61 is so large in diameter that it fills at least the lower part of the conveyor container 8—in contrast to the arrangement of FIG. 2 with a small conveying screw 26, here a large conveying screw 60 is inserted into the unchanged holder 28, which thus allows operation with different conveying screws 26, 60. Thus, the shaft 62 of the conveying screw 60 is designed in the same way as the shaft 27 of the conveying screw 26, but with the exception that instead of the stop flange 38 (FIG. 2), due to the larger dimensions of the conveying screw 60 and thus of the portion 60′, a stop shoulder 63 is now provided, with which the shaft 62 strikes the holder 28 and determines the gap between the magnets 34, 36.

During operation, the conveying helix 61 rotates counterclockwise as viewed from the shaft; however, in the embodiment shown, its beginning is not located at the stop shoulder 63 but at a distance therefrom and thus has a leading edge 64 which rotates correspondingly counterclockwise along therewith and is thus at a distance from the cover plate 40. If this distance were smaller than a dimension of the bulk material to be conveyed, such a bulk material can fall in front of the leading edge 64 during operation of the metering device 2, be caught by said leading edge and be clamped between said leading edge and the cover plate 40. If this bulk material cannot be compressed, the edge 64, thus the conveying helix 61 and thus the conveying screw 60, are pushed away from the cover plate 40 and thus also from the holder 28 and can then easily be pushed out of the holder 28 against the magnetic fastening (in the prior art with a mechanically locked conveying screw, such bulk material is simply destroyed). However, as mentioned, if the distance between the edge 64 and the cover plate 40, i.e., the shaft-side wall of the conveyor container 8, is greater than the largest dimension of a bulk material, this risk does not exist. A distance of 3 mm between the leading edge 64 and the wall of the conveyor container (or the cover plate 40) is sufficient for most bulk materials, but depending on the bulk material, a person skilled in the art can use a conveying screw with a larger distance, up to 20 mm.

This results in a metering unit 1 or a metering device 2 in which the conveying screw protrudes through a conveyor container which is filled with bulk material during operation, and wherein the beginning of the screw spiral has a leading edge 64 whose distance from the shaft-side wall of the conveyor container is, in embodiments, between 3 mm and 20 mm, in embodiments, between 5 mm and 15 mm and, in embodiments, between 8 and 12 mm. Furthermore, this results in a conveying screw 60 with a stop element 63 for a holder 28 of the conveying screw 60 and a screw spiral 61, wherein the leading edge 64 of the beginning of the screw spiral 61 has a distance from the stop element 63 of between 3 mm and 20 mm, in embodiments, between 5 mm and 15 mm and, in embodiments, between 8 and 12 mm.

1. A gravimetric metering unit for bulk materials, comprising a metering device, which has a container for bulk material to be metered and a base unit, the base unit having a conveying screw, which is operably held in position and driven by means of a holder, it being possible to axially assemble the conveying screw and the holder to one another and said conveying screw and holder being designed such that they can be operably fastened to each other by means of a plug-in connection, wherein the plug-in connection is a magnetic connection.

2. The gravimetric metering unit for bulk materials according to claim 1, wherein the magnetic connection is designed such that the fastening magnetic force acts on the conveying screw in an axial direction and pulls it against the holder.

3. The gravimetric metering unit for bulk materials according to claim 1, wherein the conveying screw has a shaft provided for interaction with the holder and the holder has an opening for receiving the shaft, and wherein the end face of the shaft facing the holder and the bottom of the opening each have a magnetic element.

4. The gravimetric metering unit for bulk materials according to claim 1, wherein the magnetic connection fastens the conveying screw in its position during operation by means of an axially acting force of 5 N to 20 N directed against the holder.

5. The gravimetric metering unit for bulk materials according to claim 1, wherein a shaft of a screw conveyor has a radially outwardly directed camber which projects beyond an adjoining shaft portion extending toward the end face of the shaft and an adjoining mounting portion extending toward a tip of the screw conveyor at least in one radial direction such that the shaft can be placed in a portion of the holder associated with the camber so as to be slightly tilted in at least this one direction and can be guided into this portion by a first section with the camber.

6. The gravimetric metering unit for bulk materials according to claim 1, wherein a shaft of the conveying screw has a radially outwardly directed camber on its end face, which camber projects beyond an adjoining mounting portion extending toward a conveying helix of the conveying screw at least in one radial direction, in such a way that the shaft can be placed in the opening of the holder so as to be slightly tilted in at least this one direction and can be guided therein by a first section with the camber.

7. The gravimetric metering unit for bulk materials according to claim 6, wherein the camber is designed to fit perfectly with the portion of the opening in which it is located in the operably inserted position of the conveying screw such that a screw conveyor is operably fitted into the holder at a first location on the shaft.

8. The gravimetric metering unit for bulk materials according to claim 1, wherein a shaft of the conveying screw has a mating portion within the length in which it projects into the opening of the holder during operation, the outer dimensions of which are designed to fit perfectly with the portion of the opening in which it is located in the operably inserted position of a screw conveyor such that the screw conveyor is operably fitted in the holder at a second location on the shaft.

9. The gravimetric metering unit for bulk materials according to claim 1, wherein a shaft of the conveying screw is limited by a stop element which strikes the holder and determines an axial position of the conveying screw operably inserted into the holder.

10. The gravimetric metering unit for bulk materials according to claim 9, wherein the stop element is positioned on the shaft such that, in the operably inserted position of a screw conveyor in the holder, a gap remains between the magnetic elements of the shaft and the holder.

11. The gravimetric metering unit for bulk materials according to claim 1, wherein the conveying screw projects through a conveyor container for bulk materials, and wherein the beginning of the conveying helix has a leading edge.

12. The gravimetric metering unit for bulk materials according to claim 9, wherein a leading edge of the conveying helix is at a distance of between 3 and 20 mm from the stop element.

13. The gravimetric metering unit for bulk materials according to claim 1, wherein a shaft of the conveying screw has at least one locking cam in the end portion facing the conveying helix, which cam, during operation, fastens the conveying screw in the holder such that it cannot rotate with a mating recess in the end portion of the holder facing the conveying helix.

14. The gravimetric metering unit for bulk materials according to claim 1, wherein the holder has a magnet at the bottom of the opening.

15. The gravimetric metering unit for bulk materials according to claim 1, wherein the opening of the holder is tubular, with a constant inner diameter over the length in which a shaft of the conveying screw projects into its opening without cams during operation.

16. The gravimetric metering unit for bulk materials according to claim 1, wherein the holder is rotatably mounted in a housing by means of ball bearings and this housing is arranged on a gear of the drive for the conveying screw.

17. A conveying arrangement for a metering device, comprising a conveying screw and a holder for said conveying screw, it being possible to axially plug the conveying screw and the holder together and these being designed such that they can be operably fastened to each other by means of a plug-in connection, wherein the plug-in connection is a magnetic connection.

18. A conveying screw for a metering device, comprising a conveyor spiral, wherein said conveying screw has a shaft which has a magnetic element at the end face.

19. The conveying screw according to claim 18, wherein the magnetic element is designed as a permanent magnet.

20. The conveying screw according to claim 18, wherein the shaft has on its end face a radially outwardly directed camber, which projects beyond an adjoining mounting portion extending toward the conveying helix at least in one radial direction such that the shaft can be placed into an opening or into a step of a holder associated with the conveying screw so as to be slightly tilted in at least one direction and can be guided therein over a first section with the camber.

21. The conveying screw according to claim 20, wherein the camber is designed for precise reception of the shaft in an opening of a holder associated with the conveying screw at a first location.

22. The conveying screw according to claim 18, wherein the shaft of the conveying screw has a mating portion for precise reception of the shaft in an opening of a holder associated with the conveying screw at a second location.

23. The conveying screw according to claim 18, wherein the shaft of the conveying screw has at least one locking cam projecting radially from said shaft in the end portion facing the conveying helix.

24. The conveying screw according to claim 18, wherein the shaft is limited by a stop element projecting radially therefrom.

25. The conveying screw according to claim 24, wherein the stop element is designed as a flange or stop shoulder.

26. The conveying screw according to claim 24, wherein a leading edge of the beginning of the conveying helix has a distance from the stop element which is between 3 mm and 20 mm.
